(19) United States
(12) Patent Application Publication
(10) Pub. No.: US 2010/0079791 A1
(43) Pub. Date: Apr. 1, 2010

(54) SCANNING APPARATUS, NETWORK SCANNING SYSTEM, AND NETWORK SCANNING METHOD THEREOF

(75) Inventor: Hong-seock Kim, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/499,154

(22) Filed: Jul. 8, 2009

(30) Foreign Application Priority Data
Sep. 26, 2008 (KR) 10-2008-94931

(51) Int. Cl. H04N 1/04; G06K 15/00

(52) U.S. Cl. 358/1.15; 358/474

(57) ABSTRACT

A scanning apparatus, a network scanning system and a network scanning method thereof, the network scanning method of the scanning apparatus that is connected to a host apparatus including: receiving inherent information with respect to the host apparatus that is a transmission target of a scan image of a scanned item; searching for one or more scanning protocols supported by the host apparatus by using the received inherent information; and displaying the one or more supported scanning protocols found in the searching. Thus, an error in a network scanning setting may be reduced, and user convenience may be improved.

### CROSS-REFERENCE TO RELATED APPLICATION

This application claims the benefit of Korean Application No. 2008-94931, filed Sep. 26, 2008 in the Korean Intellectual Property Office, the disclosure of which is incorporated herein by reference.

### BACKGROUND OF THE INVENTION

1. Field of the Invention

Aspects of the present invention relate to a scanning apparatus, a network scanning system, and a network scanning method thereof, and more particularly, to a scanning apparatus to transmit a scanning image to a host apparatus by a set scanning protocol, a network scanning system, and a network scanning method thereof.

2. Description of the Related Art

A scanning apparatus (such as a scanner a multifunction device that includes a scanning operation) scans (i.e., reads) a scan target document, and prints a generated scan image or transmits the generated scan image to an outside device by using a communicating apparatus such as a modem, a network card, a universal serial bus (USB) port, an infrared port, a Bluetooth port, etc. The scanning apparatus may be connected to a plurality of host apparatuses (such as personal computers, laptop computers, mobile phones, personal digital assistants, etc.), and may perform a network scanning operation to transmit a generated scan image to a host apparatus according to a predetermined communication protocol.

To normally perform this network scanning operation, the user previously grasps a type of a supported scanning protocol in a specific host apparatus, and performs a network scanning setting that correctly recognizes a scanning option in accordance with the scanning protocol. For example, if the host apparatus supports a file transfer protocol (FTP) as the scanning protocol, and the user mistakenly sets a scan image transmission to the host apparatus according to a server message block (SMB) protocol, or wrongly inputs an inherent setting value, a scanning operation fails to normally operate although the scanning apparatus is capable of transmitting the scan image to the host apparatus.

### SUMMARY OF THE INVENTION

Aspects of the present invention provide a scanning apparatus to search a scanning protocol supported in a host apparatus and to display the searching result to reduce an error in a network scanning setting and to improve user convenience, a network scanning system and a network scanning method thereof.

According to an aspect of the present invention, there is provided a network scanning method of a scanning apparatus that is connected to a host apparatus, the network scanning method of the scanning apparatus including: receiving inherent information with respect to the host apparatus to which a scan image of a scanned item is to be transmitted from the scanning apparatus; searching for one or more scanning protocols supported by the host apparatus by using the received inherent information; and displaying the one or more supported scanning protocols found in the searching.

The network scanning method of the scanning apparatus may further include receiving a selection of at least one of the displayed one or more supported scanning protocols.

The network scanning method of the scanning apparatus may further include receiving a setting of a scanning option corresponding to the at least one selected scanning protocol.

The network scanning method of the scanning apparatus may further include scanning the item according to the set scanning option, and transmitting the scan image to the host apparatus through the at least one selected scanning protocol.

The displaying of the one or more supported scanning protocols may include displaying a message indicating that no supported scanning protocols are found if no scanning protocols supported by the host apparatus are found in the searching.

The one or more scanning protocols may include a file transfer protocol (FTP), a server message block (SMB), a Network TWAIN, and/or a Web service.

The inherent information with respect to the host apparatus may include an internet address (IP) and/or a host name.

The receiving of the inherent information and the displaying of the one or more supported scanning protocols may be performed through a local user interface of the scanning apparatus and/or a web user interface of the host apparatus connected to the scanning apparatus.

According to another aspect of the present invention, there is provided a scanning apparatus that is connected to a host apparatus, the scanning apparatus including: a scanning unit to scan a scanning target item to generate a scan image; a user interface to receive inherent information with respect to the host apparatus that is a transmission target of the scan image; a display unit; and a control unit to search for one or more scanning protocols supported by the host apparatus by using the received inherent information, and to control the display unit to display the one or more supported scanning protocols that are found in the search.

The user interface may select at least one of the one or more displayed scanning protocols.

The user interface may set a scanning option corresponding to the at least one selected scanning protocol.

The scanning apparatus may further include a communicating unit, wherein the control unit may control the communicating unit to scan the scanning target item and to transmit the scan image to the host apparatus through the at least one scanning protocol.

The display unit may display a message indicating that no supported scanning protocols are found if no scanning protocols supported by the host apparatus are found in the search.

The scanning protocol may include a file transfer protocol (FTP), a server message block (SMB), a Network TWAIN, and/or a Web service.

The inherent information with respect to the host apparatus may include an internet address (IP) and/or a host name.

According to another aspect of the present invention, there is provided a network scanning system including: a scanning apparatus to scan a scanning target item; and a first host apparatus connected to the scanning apparatus, wherein: the scanning apparatus includes: a scanning unit to scan the scanning target item to generate a scan image, a first communicating unit to perform communication with the first host apparatus; and a first control unit to search for one or more scanning protocols supported by a target apparatus by using inherent information of the target apparatus received through the first communicating unit, and to control the first communicating unit to transmit to the first host apparatus the one or more scanning protocols supported by the target apparatus found in the search; and the first host apparatus includes: a second communicating unit to perform communication with the scanning apparatus, a display unit, a user interface to receive the inherent information with respect to the target apparatus, and a second control unit to control the second communicating unit to transmit the received inherent information to the scanning apparatus and to receive the one or more supported scanning protocols from the scanning apparatus, and to control the display unit to display the received one or more scanning protocols.

The first host apparatus and the target apparatus may be a same apparatus.

The user interface may receive a setting of a scanning option corresponding to the at least one selected scanning protocol, the second communication unit may transmit the set scanning option to the scanning apparatus, and the first control unit may control the scanning unit to scan the scanning target item according to the received scanning option, and controls the first communicating unit to transmit the scan image generated based on the scanning option to the target apparatus through the at least one selected scanning protocol.

According to yet another aspect of the present invention, there is provided a scanning apparatus that is connected to a host apparatus, the scanning apparatus including: a scanning unit to scan a scanning target item to generate a scan image; a web server to store a web page to be transmitted to the host apparatus; a control unit to search for one or more scanning protocols supported by the host apparatus, and to generate the web page to include the one or more scanning protocols found in the searching; and a communication unit to transmit the stored web page including the one or more scanning protocols to the host apparatus, to receive a selection of at least one of the one or more scanning protocols from the host apparatus, and to transmit the scan image to the host apparatus through the selected at least one scanning protocol.

According to still another aspect of the present invention, there is provided a network scanning method of a scanning apparatus that is connected to a host apparatus, the network scanning method of the scanning apparatus including: searching for one or more scanning protocols supported by a host apparatus to which a scan image of a scanned item is to be transmitted from the scanning apparatus; and transmitting the scan image to the host apparatus according to at least one scanning protocol supported by the host apparatus found in the searching.

According to another aspect of the present invention, there is provided a host apparatus connected to a scanning apparatus to receive a scan image from the scanning apparatus through a network, the host apparatus including: a display unit to display one or more scanning protocols supported by the host apparatus; an interface unit to receive a selection of at least one displayed scanning protocol supported by the host apparatus; a communication unit to transmit inherent information about the host apparatus to the scanning apparatus, to receive the one or more supported scanning protocols determined by the scanning apparatus using the transmitted inherent information, to transmit the at least one selected scanning protocol, and to receive the scan image from the scan apparatus through the at least one selected scanning protocol.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, in which:

FIG. 1 illustrates a configuration of a network scanning system according to an embodiment of the present invention;

FIG. 2 is a block diagram illustrating a configuration of a scanning apparatus according an embodiment of the present invention;

FIGS. 3A to 3D illustrate searching processes for a scanning protocol according to an embodiment of the present invention;

FIGS. 4A and 4B are flowcharts illustrating a network scanning method according to an embodiment of the present invention; and

FIGS. 5A to 7C illustrate examples of a user interface supplied in the network scanning method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

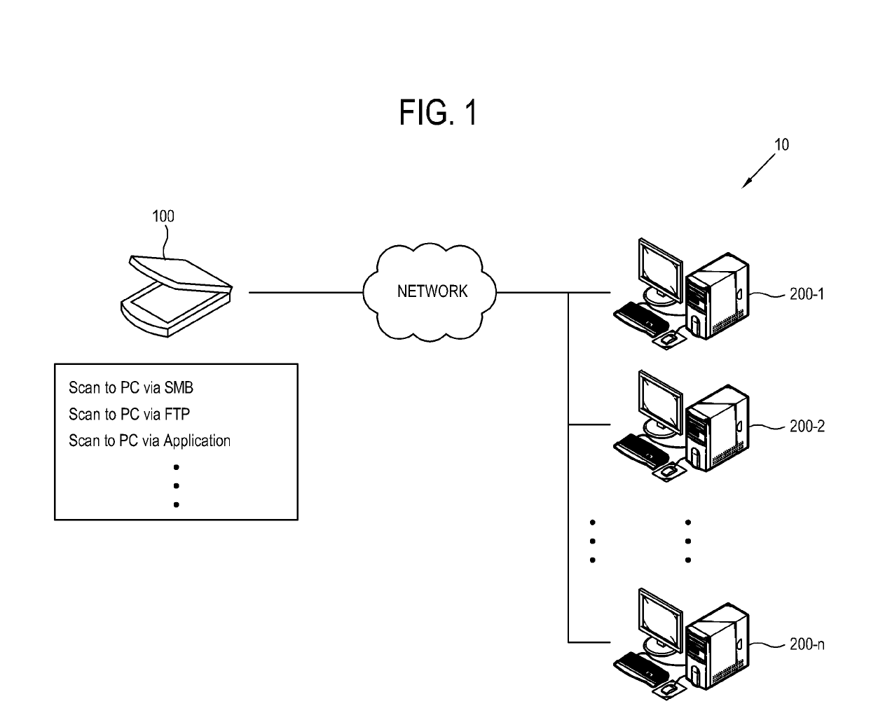

FIG. 1 schematically illustrates a configuration of a network scanning system 10 according to an embodiment of the present invention. Referring to FIG. 1, the network scanning system 10 includes a scanning apparatus 100 and at least one host apparatus 200-1, 200-2, . . . and 200-n to which a document (i.e., a scan image) is transmitted from the scanning apparatus 100. At least one host apparatus 200-1, 200-2, . . . and 200-n is connected to the scanning apparatus 100 by a network. Accordingly, the scanning apparatus 100 scans a scanning target document to generate a scan image, and transmits the generated scan image at least one host apparatus 200-1, 200-2, . . . and 200-n according to a set scanning protocol.

The scanning apparatus 100 may be implemented as a scanner, a multifunction device having one or more operations (including a scanning operation), etc., and the host apparatus 200 may be implemented as a server, a personal computer, a notebook computer, a mobile phone, a personal digital assistant (PDA), etc.

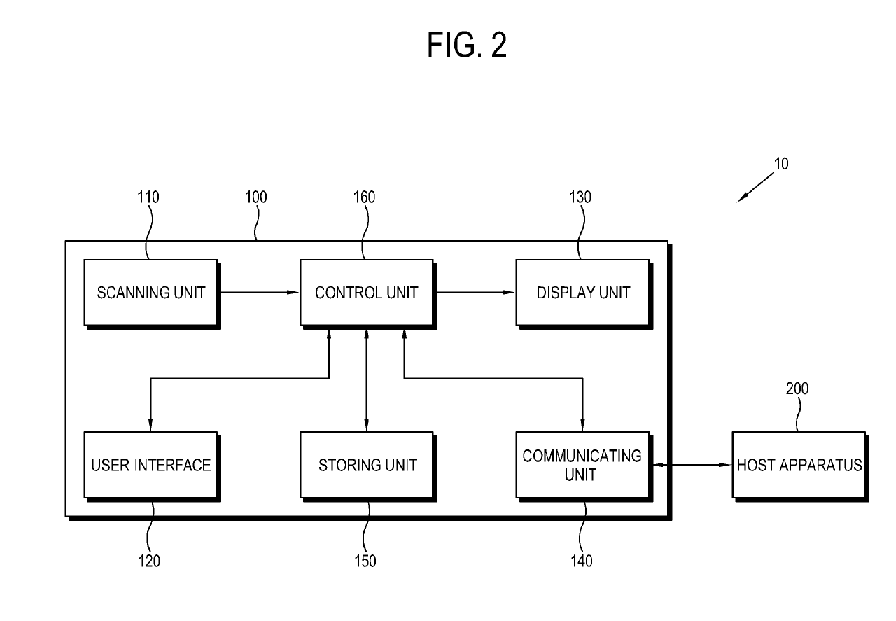

FIG. 2 is a block diagram illustrating a configuration of the scanning apparatus 100 according to an embodiment of the present invention. Referring to FIG. 2, the scanning apparatus 100 includes a scanning unit 110, a user interface 120, a display unit 130, a communicating unit 140, a storing unit 150, and a control unit 160.

The scanning unit 110 scans a scanning target document to generate a scan image. For example, the scanning target document may be a document, a picture, a film, an object, etc. Furthermore, the scanning unit 110 may use a scanning option to scan a document.

The user interface 120 receives a confirming command with respect to at least one supported scanning protocol in the host apparatus 200 that is connected to the scanning apparatus 100 through a network and is a target to transmit a scan image. The confirming command with respect to the supported scanning protocol may be a scanning command for a predetermined scanning target document, or a network setting command for an environment setting (such as the network) in the scanning apparatus 100. Furthermore, the user interface 120 may include an input panel (including, for example, one or more key buttons, a rotatable dial, a touch screen, etc.) representing operations of the scanning apparatus 100, and/or a graphic user interface (GUI) (hereinafter, will also be referred to as “local user interface (LUI)”) generated by execution of a driver or a separate application to be displayed on the display unit 130 to receive user inputs. If the user interface 120 includes the GUI, the scanning apparatus 100 displays the GUI for selecting a supported scanning protocol, and receives a setting through the displayed GUI.

Alternatively, the user interface 120 may be implemented as a web user interface (WUI) (hereinafter, will also be referred to as “remote user interface (RUI)”) displayed in at least one host apparatus 200-1, 200-2, . . . and 200-n connected to the scanning apparatus 100. If the user interface 120 is implemented as the WUI, the scanning apparatus 100 may include a web server (not shown) connected to the network, and the WUI may be a web page based on a hypertext transfer protocol (HTTP). Also, the host apparatus in which the WUI is displayed may be the same apparatus as the host apparatus 200 to which a scan image is to be transmitted.

The user interface 120 receives an inherent information to determine at least one host apparatus 200 that is the transmission target of the scan image, a selecting command to select a scanning protocol from among scanning protocols displayed on the display unit 130, a scanning option corresponding to at least one selected scanning protocol, etc. to correspond to a confirming command with respect to a scanning module. The inherent information may include an internet protocol (IP), a host name, etc.

The display unit 130 displays, to a user, a scanning protocol supported in the document transmission target host apparatus 200 to correspond to the inherent information input through the user interface 120. Here, if one or more scanning protocols are supported in the host apparatus 200, the display unit 130 displays the one or more supported scanning protocols selectable by the user. The display unit 130 may include a thin film transistor-liquid crystal display (TFT-LCD) (not shown) and a driving unit (not shown) driving the TFT-LCD.

The communicating unit 140 receives information about a supported scanning protocol from the host apparatus 200 that is the transmission target of a scan image, and transmits the scan image generated in the scanning unit 110 to the corresponding host apparatus 200. The communicating unit 140 of the scanning apparatus 100 transmits the scanning image to the host apparatus 200 according to the set scanning protocol. The communicating unit 140 may include wired and/or wireless communication modules connectable with an external device such as the host apparatus 200 by a local connection or a network connection according to a predetermined protocol, a universal serial bus (USB) port connectable with a portable storage medium such as a USB memory, etc.

The storing unit 150 stores the set scanning protocol and the scanning option information, and may be implemented as internal or external storage modules such as a hard disk drive (HDD), a flash memory, etc. Furthermore, the storing unit 150 may also store a scan image generated in the scanning unit 110.

The control unit 160 controls operations of the scanning apparatus 100. In detail, if the control unit 160 receives, through the user interface 120, a scanning command or a network scanning setting command and an inherent information of the host apparatus 200 (such as the IP of the host apparatus 200), the control unit 160 performs a search for a scanning protocol supported in corresponding host apparatus 200 that is the transmission target of a scan image. That is, the control unit 160 performs a discovery operation.

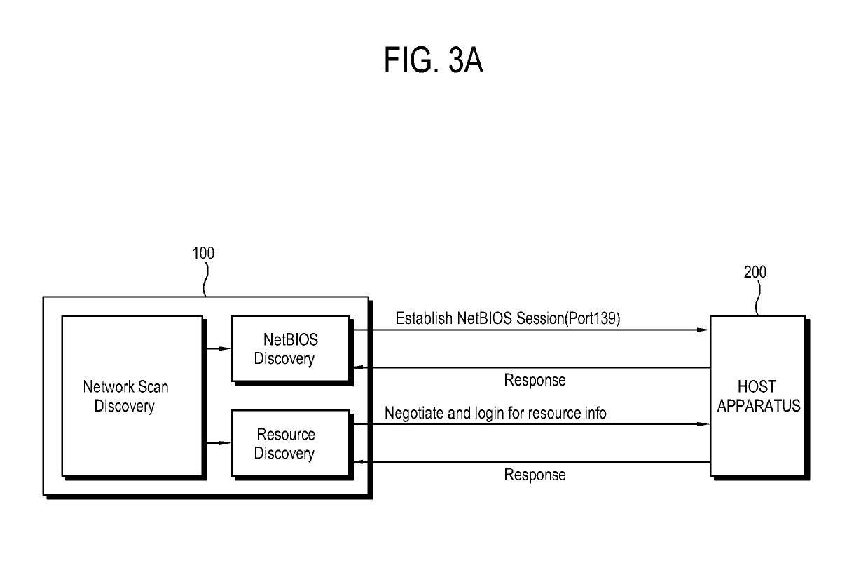

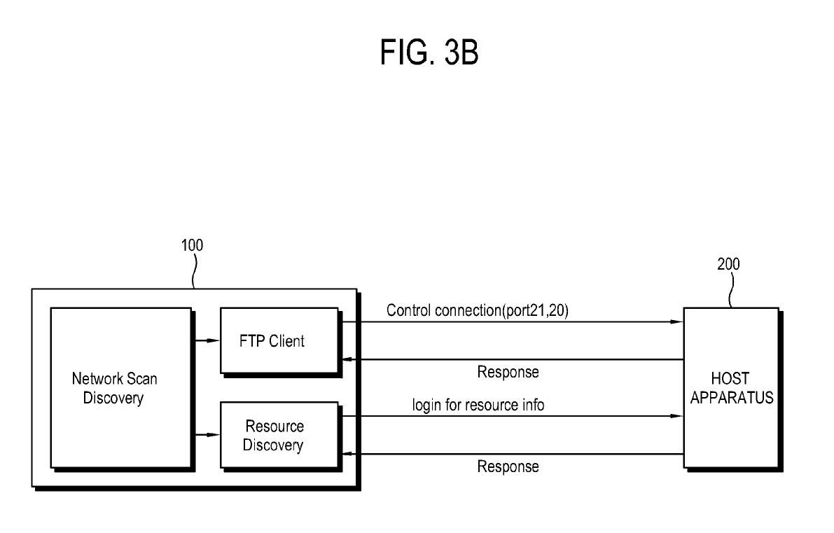

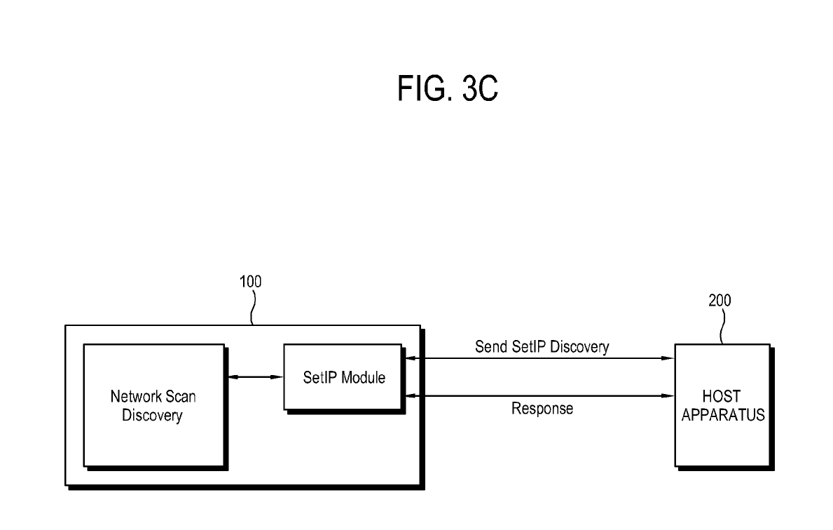

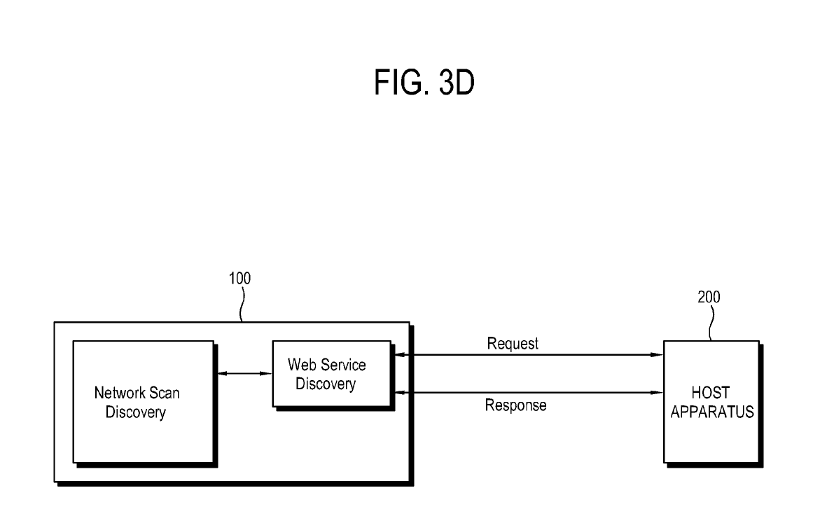

FIGS. 3A to 3D illustrate searching processes for a scanning protocol according to an embodiment of the present invention. The scanning apparatus 100 includes a discovery module (not shown) to search a supported scanning protocol. The discovery module may be added to the scanning apparatus 100 as a separate element, or may be configured so that the control unit 160 performs the discovery operation.

FIG. 3A illustrates a searching process for a scanning protocol supporting a server message block (SMB), and FIG. 3B illustrates a searching process for a scanning protocol supporting a file transfer protocol (FTP). Referring to FIGS. 3A and 3B, to search for a scanning protocol using a standardized protocol and a user account (such as SMB and FTP), it is confirmed whether the corresponding protocol operates in the host apparatus 200 through an initial setting (establish or negotiate) or connection. If a confirming response to the initial setting or connection is received from the host apparatus 200 confirming the operation of the corresponding protocol, the scanning apparatus 100 performs a login operation (for example, an anonymous login) to the host apparatus 200, and confirms a setting information of the corresponding protocol (for example, a shared folder or the position in which a scan image is storable), etc. The host apparatus 200 responsively transmits the confirmed information to the scanning apparatus 100 and ends the discovery operation.

FIG. 3C illustrates a searching process for a scanning protocol using a scanning application having an individual standard (i.e., not a standardized protocol such as the SMB and the FTP). Referring to FIG. 3C, if the scanning apparatus 100 searches for a scanning protocol using a scanning application having an individual standard (for example, a Network TWAIN), the discovery operation is performed to use the property of the corresponding scanning application. Accordingly, in case of the Network TWAIN, the searching process performs the discovery operation allowing a set IP packet analysis, and includes an operation of receiving a response corresponding to the discovery operation from the host apparatus 200.

FIG. 3D illustrates a searching process for a scanning protocol using a web service. Referring to FIG. 3D, the scanning apparatus 100 requests the host apparatus 200 to discovery a web services description language (WSDL), and receives a response from the host apparatus 200 to search for a supported scanning protocol.

In the present embodiment, the scanning apparatus 100 is illustrated to be applied to the four protocols shown in FIGS. 3A to 3D. However, it is understood that the scanning apparatus 100 may perform the discovery operation with respect to various other and/or additional scanning protocols added in the host apparatus 200, and may perform the discovery operation to be appropriate to a protocol property of the other and/or added scanning protocol. Also, aspects of the present invention may also be applied to a network scanning using an inherent information of the host apparatus 200 such as an IP and/or a host name.

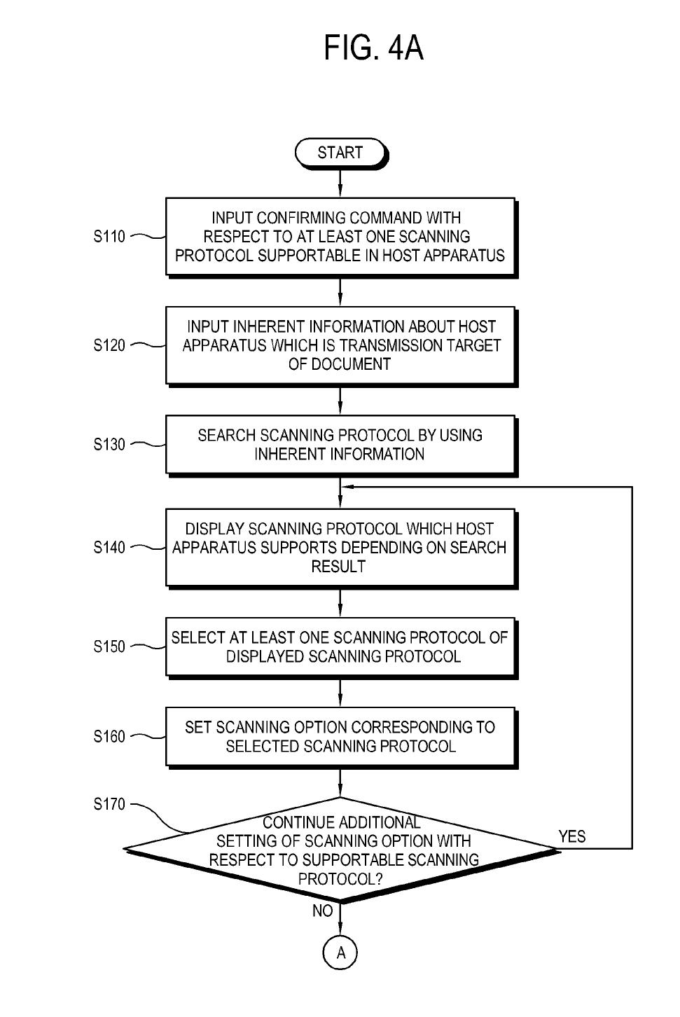

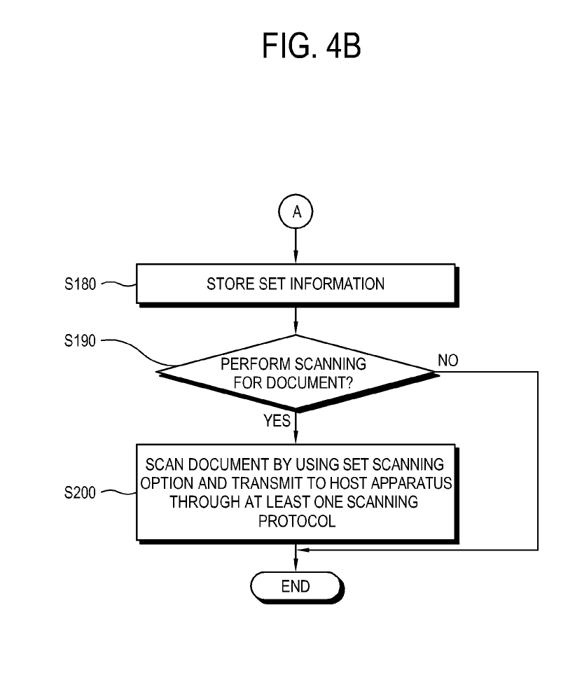

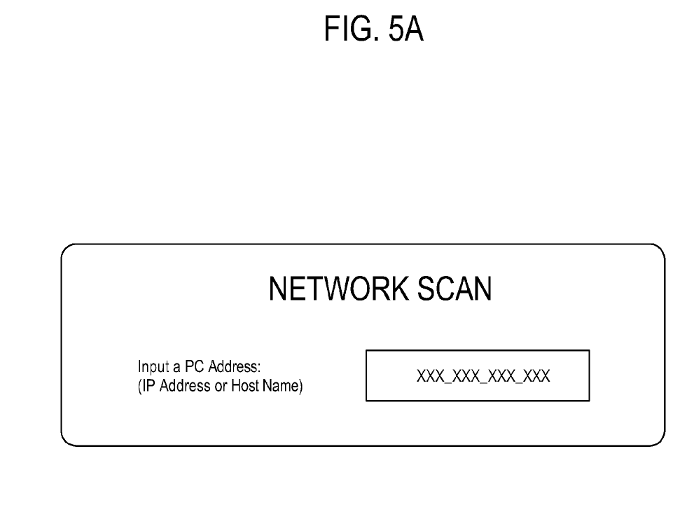

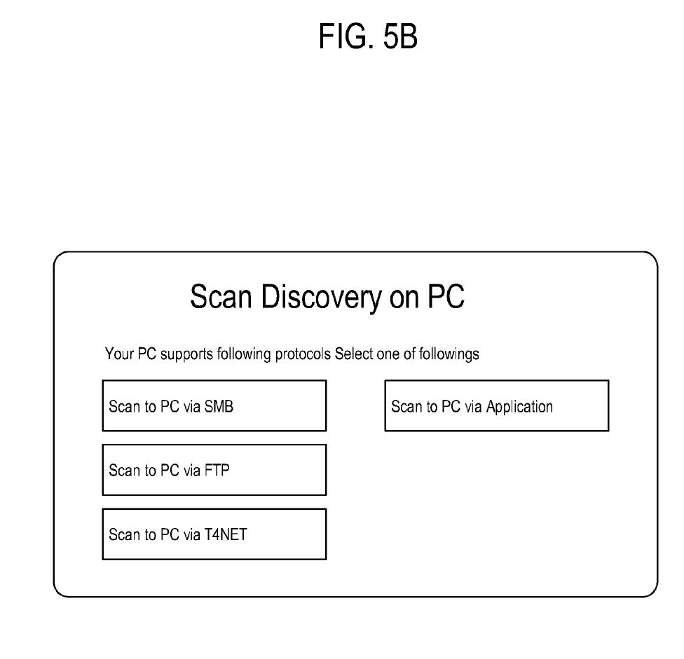

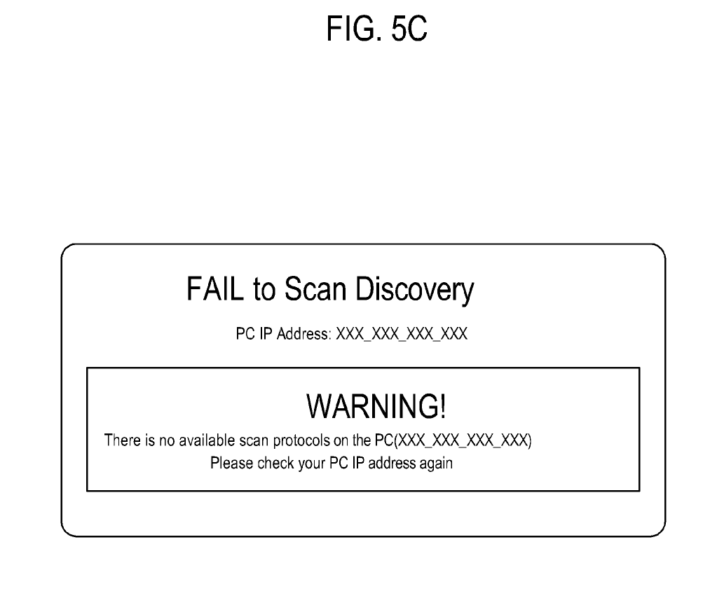

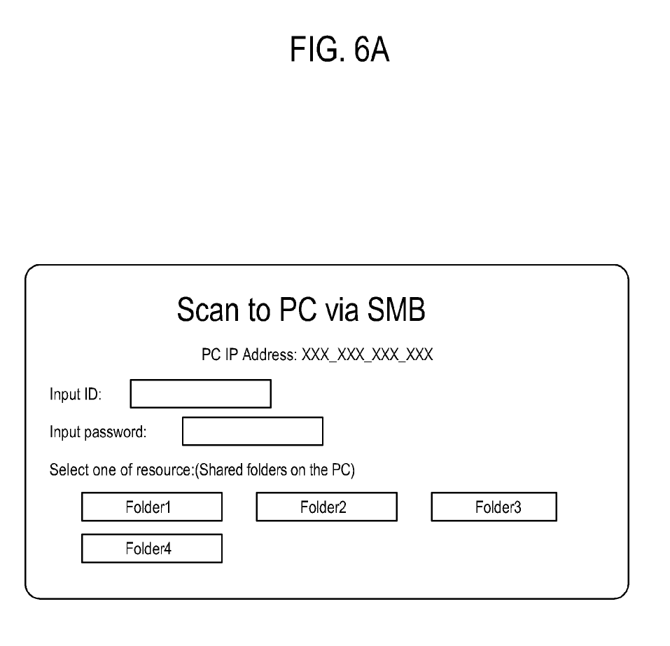

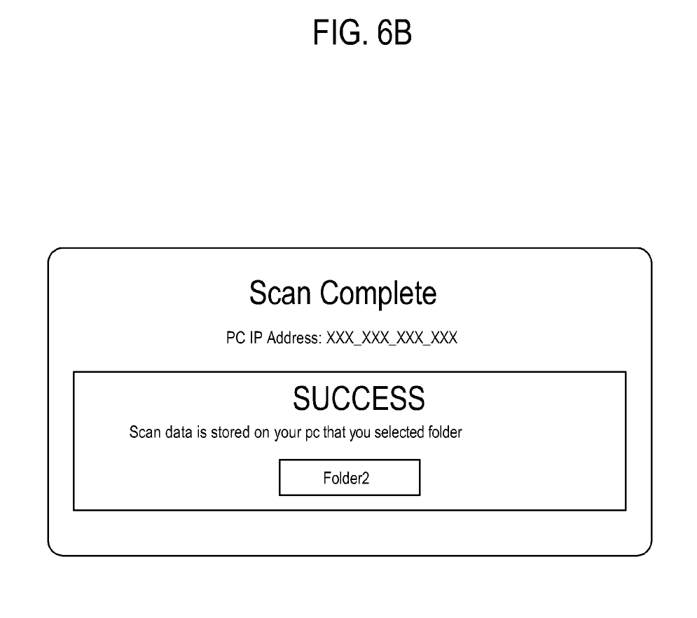

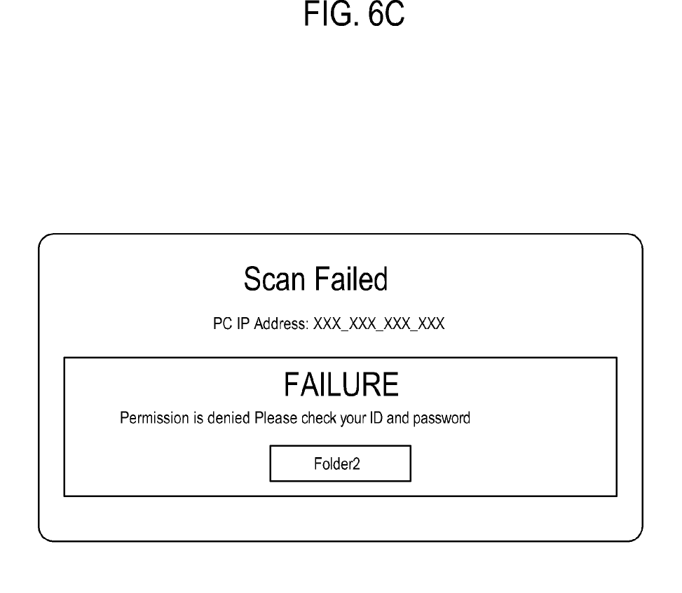

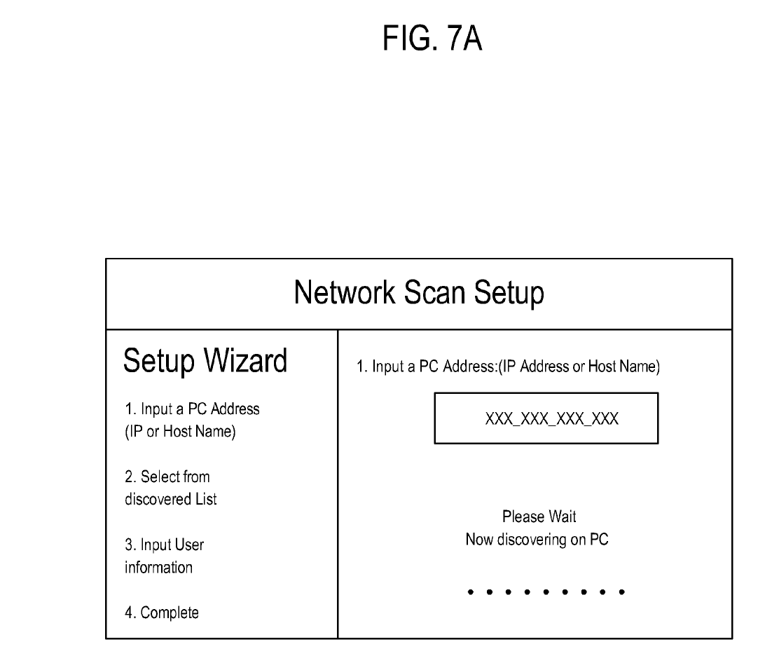

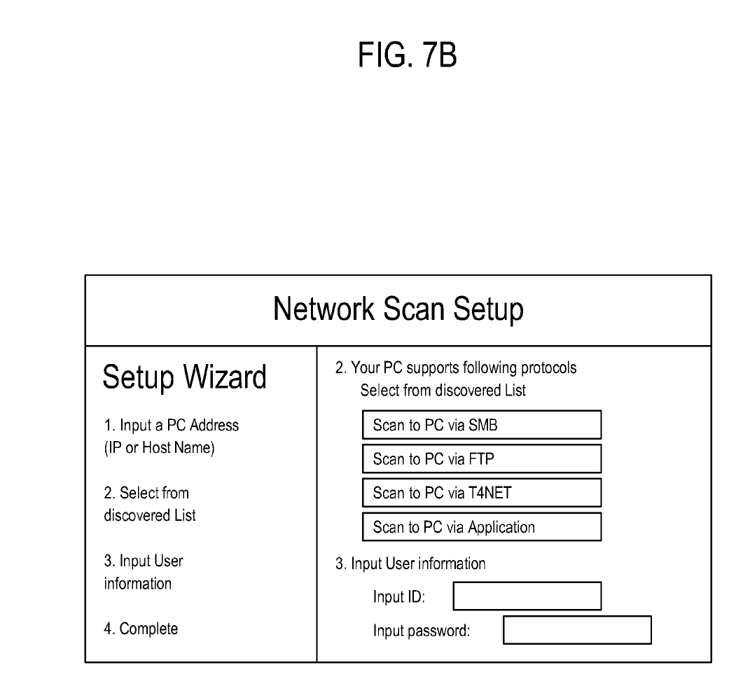

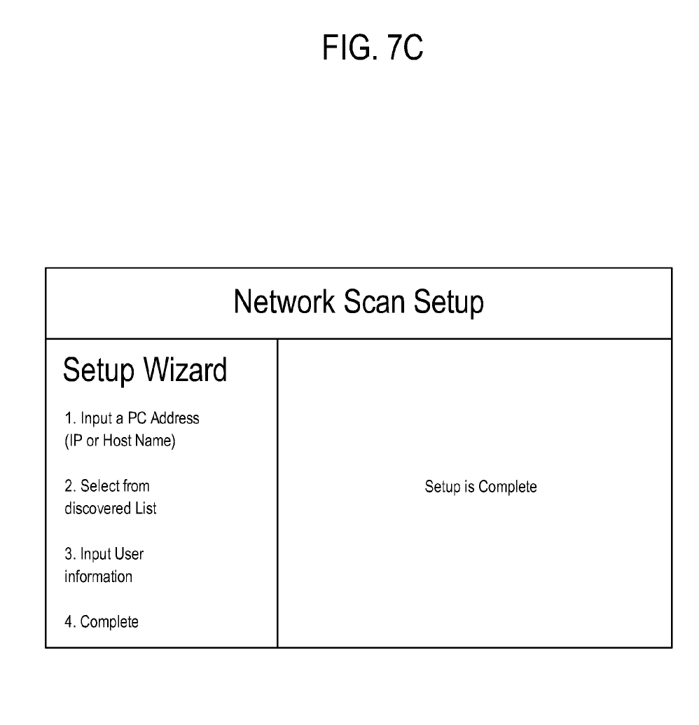

Hereinafter, a network scanning process in the network scanning system 10 including the scanning apparatus 100 and at least one host apparatus 200 will be described with reference to FIGS. 4A to 7C. FIGS. 5A to 7C illustrate examples of a user interface supplied in the network scanning method according to an embodiment of the present invention. Specifically, FIGS. 5A to 6C illustrate a local user interface (LUI) provided to the scanning apparatus 100, and FIGS. 7A to 7C illustrate a web user interface (WUI) displayed in a host apparatus 200 connected to the scanning apparatus 100.

Referring to FIG. 4A, the scanning apparatus 100 receives a confirming command with respect to at least one scanning protocol supported in the host apparatus 200 in operation S110. Here, the confirming command with respect to the scanning protocol may include a scanning command for a scanning target document, or a network setting command for the scanning apparatus 100.

The control unit 160 controls to display to a user through the display unit 130 a user interface (UI) (as illustrated in FIG. 5A) to receive an inherent information of the host apparatus 200 that is the transmission target of a scan image corresponding to the input confirming command, and receives the inherent information of the host apparatus 200 through the displayed UI in operation S120. The input inherent information of the host apparatus 200 may include an IP and/or a host name.

The scanning apparatus 100 searches for a scanning protocol supported in the document transmission target host apparatus 200 corresponding to the input inherent information in operation S130. Here, the searching process may be performed as described above with reference to FIGS. 3A to 3D.

In operation S140, the control unit 160 displays a scanning protocol that the host apparatus 200 supports in the display unit 130 according to a result of the searching (operation S130), as shown in FIG. 5B. Here, the control unit 160 may display one or more selectable scanning protocols.

On the other hand, if a supported scanning protocol is not found in operation S130, the control unit 160 may control the display unit 130 to display a message informing that there is no searching result, as shown in FIG. 5C. The displayed message may include a request to input information of a searching target host apparatus 200 again, or to confirm the setting of the corresponding host apparatus 200.

The scanning apparatus 100 selects a displayed scanning protocol through the user interface 120 in operation S150.

The control unit 160 sets a scanning option corresponding to the selected scanning protocol in operation S160. In detail, the control unit 160 may set the scanning option through a displayed UI as shown in FIG. 6A. Referring to FIG. 6A, if the selected scanning protocol is the SMB, the set scanning option may include a folder in which a scan image is stored, a user login information of a transmission target host apparatus 200, etc. Furthermore, the setting of the scanning option may include an operation of displaying, to a user, a network scanning setting result according to the scanning option setting. For example, if the network scanning setting is normally set according to the set scanning option, the control unit 160 may control the display unit 130 to display a message representing that the setting is normally completed as shown in FIG. 6B. Conversely, if the network scanning setting fails, the control unit 160 may control the display unit 130 to display a message representing that the setting fails as shown in FIG. 6C.

As described above, if the setting with respect to a predetermined network scanning protocol is completed, the scanning apparatus 100 determines, through the user interface 120, whether a setting with respect to an additional supported scanning protocol is to be input in operation S170. In response to a user selecting to continue the network scanning setting (operation S170), the control unit 160 controls the display unit 130 to display again a supported scanning protocol in the operation S140, and performs the selecting process with respect to the displayed scanning protocol and the scanning option setting (operation S140 to S160) again. Accordingly, the scanning apparatus 100 can additionally perform the network scanning setting with respect to the host apparatus 200, the scanning protocol of which is set.

In contrast, if the user selects to suspend the network scanning setting (operation S170), the control unit 160 stores the set network scanning setting information in the storing unit 150 in operation S180.

Then, if the confirming command input in the operation S110 is a scanning command for a scanning target document, the scanning apparatus 100 performs a scanning of the document in operation S190. In contrast, if the confirming command in the operation S110 is not the scanning command (for example, the network setting command), the scanning apparatus 100 may separately receive the scanning command through the user interface 120.

If the scanning of the document is determined to be performed (operation S190), the control unit 160 controls the scanning unit 110 to scan the scanning target document and generate a scan image according to the set scanning option, and controls the communicating unit 140 to transmit the generated scan image to one or more host apparatuses 200 through at least one supported scanning protocol in operation S200.

According to another embodiment of the present invention, the network scanning setting process described with reference to FIG. 4 may be performed through a WUI connectable to a web page through the host apparatuses 200-1, 200-2, . . . and 200-n such as a personal computer, etc. as shown in FIGS. 7A to 7C in addition to the LUI provided to the scanning apparatus 100 as shown in FIGS. 5A to 6C.

If the network scanning setting is performed through the WUI, the scanning apparatus 100 is provided with a web server (not shown) in which a web page that allows setting of the scanning protocol and the scanning option is stored. The host apparatus in which the WUI is displayed receives the web page from the scanning apparatus 100 to display through the WUI, and receives selections and inputs of a user by using the displayed WUI to transmit to the scanning apparatus 100. Accordingly, the selection and input information transmitted to the scanning apparatus 100 is stored in the web server, and the setting of the network scanning is performed.

In detail, the scanning apparatus 100 transmits the WUI as shown in FIG. 7A to be displayed in at least one host apparatus 200-1, 200-2, . . . and 200-n to correspond to the scanning protocol confirming command in operation S110, and receives an inherent information of the host apparatus 200 that is the transmission target of a document in operation S120. Here, the host apparatuses 200-1, 200-2, . . . and 200-n in which the WUI is displayed and the host apparatus 200 that is the document transmission target may be the same apparatus or different apparatuses.

The scanning apparatus 100 searches for a scanning protocol supported in the host apparatus 200 in operation S130, and displays the search result in the operation S130 to a user through the WUI as shown in FIG. 7B in operation S140.

The user selects one or more supported scanning protocols through the WUI in operation S150, and sets the scanning option with respect to the selected scanning protocol in operation S160. If the setting of the scanning option with respect to the scanning protocol is completed (operation S160), the scanning apparatus 100 displays a message indicating completion of the setting to the user through the WUI as show in FIG. 7C, and the set information is transmitted to and stored in the web server of the scanning apparatus 100 in operation S170.

The scanning apparatus 100 according aspects of the present invention performs, in advance, a discovery operation with respect to a supported scanning protocol without a separate application in the network scanning setting of the host apparatus 200 connected on the network, and displays, in advance, to a user the search result of the scanning protocol supported in the host apparatus 200, thereby reducing an error in the network scanning setting and improving user convenience.

While in the above-described embodiments, the network scanning setting of one host apparatus 200 connected to the scanning apparatus 100 is described, it is understood that aspects of the present invention are not limited thereto. Alternatively, an independent network scanning setting may be performed with respect to each host apparatus 200-1, 200-2, . . . and 200-n shown in FIG. 1. Furthermore, while in the above-described embodiments, the user selects a scanning protocol through though scanning apparatus 100 or a WUI displayed on the host apparatus 200, it is understood that aspects of the present invention are not limited thereto. For example, according to other aspects, the scanning apparatus 100 may simply transmit a data signal including information on the supported protocols to be displayed on the host apparatus 100.

While not restricted thereto, aspects of the present invention can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

As described above, a scanning apparatus, a network scanning system and a network scanning method thereof according to aspects of the present invention searches a supported scanning protocol in a host apparatus, and displays the searching result to a user in advance, thereby reducing an error in a network scanning setting and improving user convenience.

Although a few embodiments of the present invention have been shown and described, it will be appreciated by those skilled in the art that changes may be made in this embodiment without departing from the principles and spirit of the invention, the scope of which is defined in the claims and their equivalents.

What is claimed is:

1. A network scanning method of a scanning apparatus that is connected to a host apparatus, the network scanning method of the scanning apparatus comprising:
receiving inherent information with respect to the host apparatus to which a scan image of a scanned item is to be transmitted from the scanning apparatus;
searching for one or more scanning protocols supported by the host apparatus by using the received inherent information; and
displaying the one or more supported scanning protocols found in the searching,
wherein the one or more scanning protocols comprise a file transfer protocol (FTP), a server message block (SMB), a Network TWAIN, and/or a Web service.

2. The network scanning method of the scanning apparatus as claimed in claim 1, further comprising receiving a selection of at least one of the displayed one or more supported scanning protocols.

3. The network scanning method of the scanning apparatus as claimed in claim 2, wherein the receiving of the selection comprises receiving of the selection of the at least one of displayed one or more supported scanning protocols from the host apparatus.

4. The network scanning method of the scanning apparatus as claimed in claim 2, further comprising receiving a setting of a scanning option corresponding to the at least one selected scanning protocol.

5. The network scanning method of the scanning apparatus as claimed in claim 4, further comprising:
scanning the item according to the set scanning option; and
transmitting the scan image of the scanned item to the host apparatus through the at least one selected scanning protocol.

6. The network scanning method of the scanning apparatus as claimed in claim 1, wherein the displaying of the one or more supported scanning protocols comprises displaying a message indicating that no supported scanning protocols are found if no scanning protocols supported by the host apparatus are found in the searching of the one or more scanning protocols.

7. The network scanning method of the scanning apparatus as claimed in claim 1, wherein the inherent information with respect to the host apparatus comprises an internet address (IP) and/or a host name.

8. The network scanning method of the scanning apparatus as claimed in claim 1, wherein the receiving of the inherent information and the displaying of the scanning protocol are performed through a local user interface of the scanning apparatus and/or a web user interface of the host apparatus connected to the scanning apparatus.

9. The network scanning method of the scanning apparatus as claimed in claim 8, further comprising:
storing, in a web server of the scanning apparatus, a web page to display the one or more supported scanning protocols; and
transmitting the web page to the host apparatus to be displayed through the web user interface.

10. A scanning apparatus that is connected to a host apparatus, the scanning apparatus comprising:
a scanning unit to scan a scanning target item to generate a scan image;
a user interface to receive inherent information with respect to the at host apparatus to which the scan image is to be transmitted;
a display unit; and
a control unit to search for one or more scanning protocols supported by the host apparatus by using the received inherent information, and to control the display unit to display the one or more scanning protocols found in the searching,
wherein the one or more scanning protocols comprise a file transfer protocol (FTP), a server message block (SMB), a Network TWAIN, and/or a Web service.

11. The scanning apparatus as claimed in claim 10, wherein the user interface receives a selection of at least one of the displayed one or more supported scanning protocols.

12. The scanning apparatus as claimed in claim 11, wherein the user interface receives a setting of a scanning option corresponding to the at least one selected scanning protocol.

13. The scanning apparatus as claimed in claim 12, further comprising a communicating unit,
wherein the control unit controls the scanning unit to scan the scanning target item and the communicating unit to transmit the scan image of the scanned item to the host apparatus through the at least one selected scanning protocol.

14. The scanning apparatus as claimed in claim 10, wherein the display unit displays a message indicating that no supported scanning protocols are found no scanning protocols supported by the host apparatus are found in the searching.

15. A network scanning system comprising:
a scanning apparatus to scan a scanning target item; and
a first host apparatus connected to the scanning apparatus, wherein:
the scanning apparatus comprises:
a scanning unit to scan the scanning target item to generate a scan image,
a first communicating unit to perform communication with the first host apparatus, and
a first control unit to search for one or more scanning protocols supported by a target apparatus by using inherent information of the target apparatus received through the first communicating unit, and to control the first communicating unit to transmit to the first host apparatus the one or more scanning protocols supported by the target apparatus found in the search; and
the first host apparatus comprising:
a second communicating unit to perform communication with the scanning apparatus,
a display unit,
a user interface to receive the inherent information with respect to the target apparatus, and
a second control unit to control the second communicating unit to transmit the received inherent information to the scanning apparatus and to receive the one or more supported scanning protocols from the scanning apparatus, and to control the display unit to display the received one or more supported scanning protocols,
wherein the inherent information with respect to the host apparatus comprises an internet address (IP) and/or a host name.

16. The network scanning system as claimed in claim 15, wherein the first host apparatus and the target apparatus are a same apparatus.

17. The network scanning system as claimed in claim 16, wherein:
the user interface receives a selection of at least one of the displayed one or more supported scanning protocols and a setting of a scanning option corresponding to the at least one selected scanning protocol;
the second communicating unit transmits the at least one selected scanning protocol and the set scanning option to the scanning apparatus; and
the first control unit controls the scanning unit to scan the scanning target item according to the received scanning option, and controls the first communicating unit to transmit the scan image generated based on the scanning option to the target apparatus through the at least one selected scanning protocol.

18. A scanning apparatus that is connected to a host apparatus, the scanning apparatus comprising:
a scanning unit to scan a scanning target item to generate a scan image;
a web server to store a web page to be transmitted to the host apparatus;
a control unit to search for one or more scanning protocols supported by the host apparatus, and to generate the web page to include the one or more scanning protocols found in the searching; and
a communication unit to transmit the stored web page including the one or more scanning protocols to the host apparatus, to receive a selection of at least one of the one or more scanning protocols from the host apparatus, and to transmit the scan image to the host apparatus through the selected at least one scanning protocol.

19. A network scanning method of a scanning apparatus that is connected to a host apparatus, the network scanning method of the scanning apparatus comprising:
searching for one or more scanning protocols supported by a host apparatus to which a scan image of a scanned item is to be transmitted from the scanning apparatus;
receiving a selection of the at least one scanning protocol from among the one or more supported scanning protocols found in the searching; and
transmitting the scan image to the host apparatus according to at least one scanning protocol supported by the host apparatus found in the searching.
